(19) United States
(12) Patent Application Publication
(10) Pub. No.: US 2016/0092971 A1
(43) Pub. Date: Mar. 31, 2016

(54) CONTENT DISTRIBUTION SYSTEM, CONTENT DISTRIBUTION SERVER, STORAGE MEDIUM AND CONTENT DISTRIBUTION METHOD

(71) Applicant: NINTENDO CO., LTD., Kyoto (JP)

(72) Inventors: Yasumasa NAKAI, Kyoto (JP); Eiji TOKUNAGA, Kyoto (JP); Koichi NAKAO, Kyoto (JP); Hitoshi SAKAI, Kyoto (JP); Teruhiko GODA, Kyoto (JP)

(21) Appl. No.: 14/795,141

(22) Filed: Jul. 9, 2015

(30) Foreign Application Priority Data
Sep. 26, 2014 (JP) 2014-196019

(51) Int. Cl. G06Q 30/06; G06Q 20/12

(52) U.S. Cl. CPC G06Q 30/0635; G06Q 20/1235; G06Q 2220/10

(57) ABSTRACT

A non-limiting example content distribution system comprises a content server that is connected communicably with a game apparatus via a network. If it is decided to reservation-purchase of a content according to an operation of a user, the content server distributes a reservation content to a game apparatus. The reservation content is a content that a part of a normal content that can be executed by the game apparatus is changed to be inexecutable (unable to start). If reaching a date and time of a sale start of the content or an executable date and time, the game apparatus is downloaded with a modifying program for the reservation content according to an operation of the user to modify the reservation content. Therefore, the reservation content can be changed to a normal content.

### CROSS REFERENCE OF RELATED APPLICATION

The disclosure of Japanese patent application No. 2014-196019 filed on Sep. 26, 2014 is incorporated by reference.

### FIELD

This application describes a content distribution system, a content distribution server, a storage medium and a content distribution method, wherein a reservation-purchased content is distributed prior to a sale start.

### SUMMARY

It is a primary object of the present embodiment(s) to provide a novel content distribution system, content distribution server, storage medium and content distribution method.

It is another object of the present embodiment(s) to provide a content distribution system, content distribution server, storage medium and content distribution method, capable of improving convenience of download sale of a content.

It is a further object of the present embodiment(s) is to provide a content distribution system, content distribution server, storage medium and content distribution method, capable of dispersing a load on a side that distributes a content.

A first embodiment is a content distribution system comprising a storing module, a content transmitting module and a data transmitting module. The storing module is configured to store a second content that corresponds to a first content that is normal and can be executed by an information processing apparatus, but cannot be executed by the information processing apparatus. The content transmitting module is configured to transmit the second content to the information processing apparatus when settling an account for the first content prior to a sale start of the first content. The data transmitting module is configured to transmit to the information processing apparatus change data that can change the second content to the first content after transmission of the second content. Therefore, the information processing apparatus changes, when receiving the change data, the second content to the first content using the change data. Accordingly, a first content being changed is performed, for example.

According to the first embodiment, the second content that is inexecutable is transmitted prior to the sale start, and then, the change data that can change the second content to a first content that is executable is transmitted, and therefore, if passing a sale start date and time, for example, the first content becomes to be used immediately only by acquiring the change data. Accordingly, it is possible to improve convenience of download sale. Furthermore, it is avoidable that access concentrates on the apparatus that distributes a content at a specific date and time such as a sale start date and time. That is, it is possible to disperse a load on a side that distributes a content.

A second embodiment is according to the first embodiment, wherein the change data is data of a modifying program (patch) that can modify the second content.

In the second embodiment, since only the data of the modifying program is transmitted, after reaching the sale start date and time, the first content can be used immediately by applying the modifying program to the second content.

A third embodiment is according to the second embodiment, wherein the first content includes a regular executable code with which a content can be executed, and the second content includes a dummy executable code with which a content cannot be executed, and the modifying program modifies the dummy executable code to a regular executable code.

According to the third embodiment, since only modifying the dummy code to a regular executable code, it is possible to lessen a data amount of the change data. Accordingly, the change data can be downloaded in a short time.

A fourth embodiment is according to the first embodiment, wherein the second content is data that at least a part of the first content is encrypted, and the change data is data of a decryption key that can decrypt the second content to the first content.

Also in the fourth embodiment, like the second embodiment, after reaching the sale start date and time, it is possible to use the first content immediately by decrypting the second content to the first content.

A fifth embodiment is according to the first embodiment, wherein the data transmitting module is configured to transmit automatically the change data to the information processing apparatus. Therefore, the information processing apparatus receives the change data and changes the second content to the first content.

According to the fifth embodiment, since the change data is transmitted automatically and the second content is changed to the first content in the information processing apparatus, a user is not troubled.

A sixth embodiment is according to the first embodiment, wherein the data transmitting module is configured to transmit the change data after transmission of the second content on or before the sale start date and time. For example, the change data may be transmitted before the sale start date and time or on the sale start date and time. According to the sixth embodiment, the second content can be changed to the first content before the sale start or immediately after the sale start. Accordingly, as a privilege of purchasing the content in advance, the user can use the content earlier than a user who purchases the content after the sale start.

A seventh embodiment is according to the first embodiment, wherein the information processing apparatus comprises an access module, a reservation module and a settlement instructing module. The access module is configured to access a predetermined site according to an operation of a user. The reservation module is configured to reserve purchase of the first content before the sale start according to an operation of the user when the access module accesses the predetermined site. Then, the settlement instructing module is configured to instruct settlement of accounts for the first content according to an operation of the user when the purchase of the first content is reserved by the reservation module.

According to the seventh embodiment, since the settlement of accounts for the first content is performed when the purchase of the first content is reserved, it is possible to save the time and effort performing these procedures separately.

An eighth embodiment is according to the seventh embodiment, wherein the content transmitting module is configured to transmit the second content to the information processing apparatus responding to having settled accounts for the first content at a time of reservation by the information processing apparatus.

According to the eighth embodiment, since the second content is transmitted according to having settled accounts at the time of reservation, it is possible to make the user acquire the second content before the sale start.

A ninth embodiment is according to the first embodiment, wherein the information processing apparatus comprises an exchange number transmitting module. The exchange number transmitting module is configured to transmit an exchange number indicated on a trading medium that is associated with the first content purchased prior to the sale start to the content transmitting module according to an operation of the user. The content transmitting module is configured to transmit the second content corresponding to the exchange number responding to having received the exchange number that is transmitted by the exchange number transmitting module when accounts is settled for the first content responding to having purchased the trading medium.

According to the ninth embodiment, even if the user purchases the trading medium in advance, the user can reservation-purchase of the first content and acquire the second content corresponding to this first content.

A tenth embodiment is according to the first embodiment, wherein the information processing apparatus comprises a content receiving module and an adding module. The content receiving module is configured to receive the second content transmitted by the content transmitting module. The adding module is configured to add the second content received by the content receiving module to a content execution menu.

According to the tenth embodiment, since the second content is added to the content execution menu responding to having received the second content, the user can recognize easily having reservation-purchased the first content.

An eleventh embodiment is according to the tenth embodiment, wherein the information processing apparatus further comprises a content execution module and a notification module. The content execution module is configured to execute the first content selected in the content execution menu by the user. The notification module is configured to notify, when the second content is selected by the user in the content execution menu, execution impossibility of the second content.

According to the eleventh embodiment, since the execution impossibility of the second content is notified when the second content is selected in the content execution menu, the user can know easily that starting is restricted for the second content.

A twelfth embodiment is according to the first embodiment, wherein the content transmitting module is configured to transmit the first content after the sale start.

According to the twelfth embodiment, since the first content is transmitted after the sale start, it is not necessary to receive the change data and to change the second content to the first content.

A thirteenth embodiment is according to the first embodiment, and further comprises a content distribution server that comprises the storing module, the content transmitting module and the data transmitting module, and the information processing apparatus comprises a settlement instructing module configured to instruct settlement of accounts for the first content according to an operation of a user, a content receiving module configured to receive the second content transmitted by the content transmitting module, and a data receiving module configured to receive the change data transmitted by the data transmitting module.

Also in the thirteenth embodiment, like the first embodiment, convenience of download sale can be improved and a load on a side that distributes a content can be dispersed.

A fourteenth embodiment is a content distribution server, comprising: a storing module configured to store a second content that corresponds to a first content that is normal and can be executed by an information processing apparatus, but cannot be executed by the information processing apparatus; a content transmitting module configured to transmit the second content to the information processing apparatus when accounts is settled for the first content prior to a sale start of the first content; and a data transmitting module configured to transmit to the information processing apparatus change data that can change the second content to the first content after transmission of the second content.

A fifteenth embodiment is a non-transitory storage medium storing a content distribution program that is executed by a content distribution server comprising a storing module configured to store a second content that corresponds to a first content that is normal and can be executed by an information processing apparatus, but cannot be executed by the information processing apparatus, wherein the content distribution program causes the content distribution server to function as: a content transmitting module configured to transmit the second content to the information processing apparatus when accounts is settled for the first content prior to a sale start of the first content; and a data transmitting module configured to transmit to the information processing apparatus change data that can change the second content to the first content after transmission of the second content.

A sixteenth embodiment is a content distribution method of a content distribution server comprising a storing module configured to store a second content that corresponds to a first content that is normal and can be executed by an information processing apparatus, but cannot be executed by the information processing apparatus, wherein the content distribution server performs: transmitting the second content to the information processing apparatus when accounts is settled for the first content prior to a sale start of the first content; and transmitting to the information processing apparatus change data that can change the second content to the first content after transmission of the second content.

Also in any one of the fourteenth to sixteenth embodiments, like the first embodiment, convenience of download sale can be improved and a load on a side that distributes a content can be dispersed.

The above described objects and other objects, features, aspects and advantages of the embodiment(s) will become more apparent from the following detailed description when taken in conjunction with the accompanying drawings.

### BRIEF DESCRIPTION OF THE DRAWINGS

FIG. 1 is an illustration view showing a non-limiting example content distribution system of a present embodiment.

FIG. 2 is a block diagram showing non-limiting example electric structure of a content server shown in FIG. 1.

FIG. 3 is a block diagram showing non-limiting example electric structure of game apparatus shown in FIG. 1.

FIG. 4 is an illustration view showing a non-limiting example download card associated with a specific application program.

FIG. 5 is an illustration view showing non-limiting example card management information managed by a management server.

FIG. 6 is an illustration view showing non-limiting example distribution information managed by the content server.

FIG. 7(A) is an illustration view showing a non-limiting example main menu screen, and FIG. 7(B) is an illustration view showing a non-limiting example download menu screen.

FIG. 8(A) is an illustration view showing a non-limiting example number input screen, and FIG. 8(B) is an illustration view showing a non-limiting example reception confirmation screen.

FIG. 9(A) is an illustration view showing a non-limiting example list screen, and FIG. 9(B) is an illustration view showing a non-limiting example purchase confirmation screen.

FIG. 10(A) is an illustration view showing another non-limiting example main menu screen, and FIG. 10(B) is an illustration view showing the other non-limiting example of main menu screen.

FIG. 11 is an illustration view showing a non-limiting example memory map of a RAM of the content server shown in FIG. 2.

FIG. 12 is an illustration view showing a non-limiting example memory map of a RAM of the game apparatus shown in FIG. 3.

FIG. 13 is a flowchart showing a part of non-limiting example content distribution processing of a CPU of the content server.

FIG. 14 is a flowchart showing another part of the content distribution processing of the CPU of the content server, following FIG. 13.

FIG. 15 is a flowchart showing the other part of the content distribution processing of the CPU of the content server, following FIG. 13.

FIG. 16 is a flowchart showing a part of non-limiting example download processing of a CPU of the game apparatus.

FIG. 17 is a flowchart showing another part of the download processing of the CPU of the game apparatus, following FIG. 16.

FIG. 18 is a flowchart showing the other part of the download processing of the CPU of the game apparatus, following FIG. 16.

FIG. 19 is a flowchart showing a non-limiting example application execution processing of the CPU of the game apparatus.

### DETAILED DESCRIPTION OF NON-LIMITING EXAMPLE EMBODIMENTS

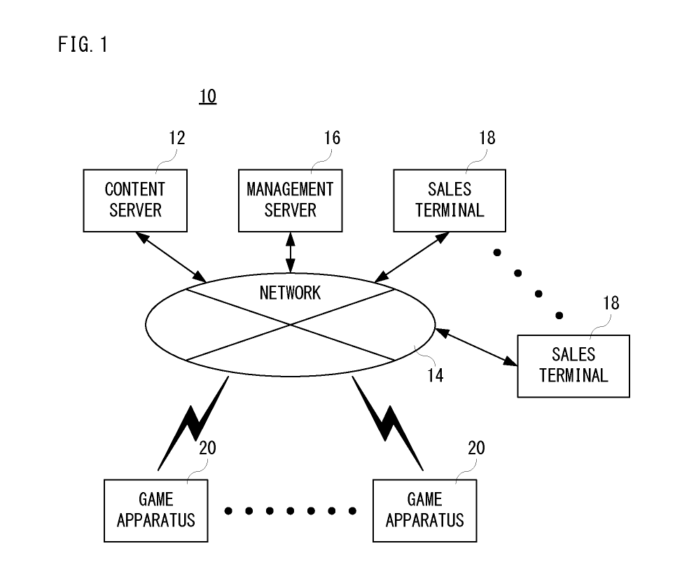

With reference to FIG. 1, a non-limiting example content distribution system 10 includes a content server 12. The content server 12 is connected to a management server 16 and a plurality of sale terminals 18 via a network 14 such as the Internet in a communicable manner, and further to a plurality of game apparatuses 20 in a communicable manner.

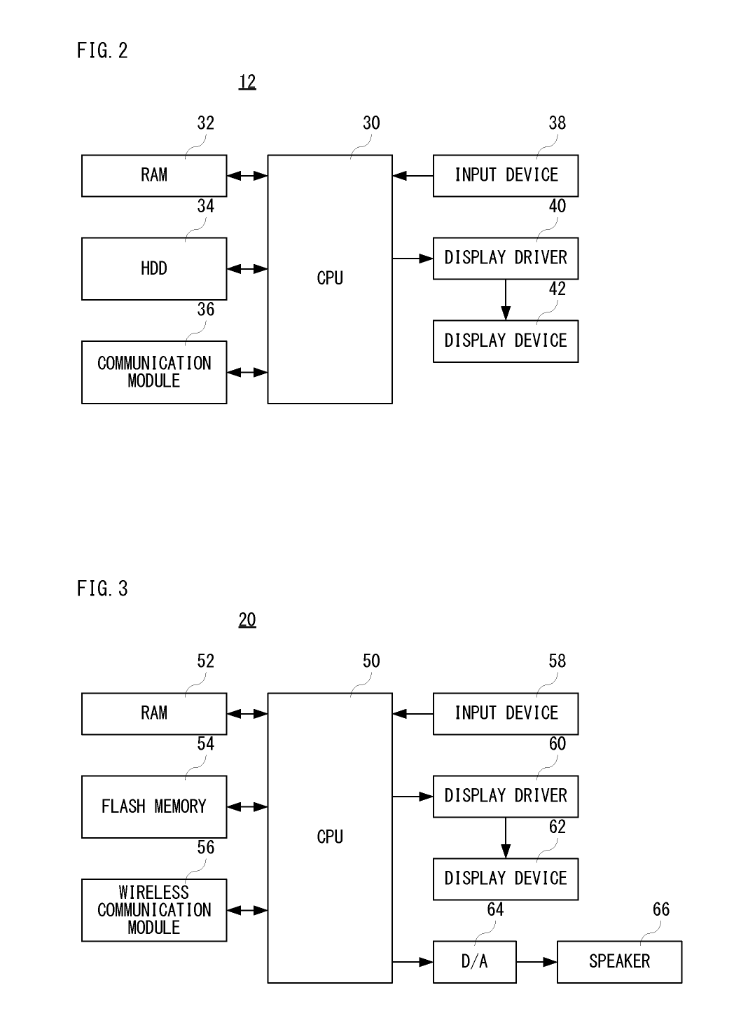

FIG. 2 is a block diagram showing electric structure of the content server 12 shown in FIG. 1. The content server 12 may be a general-purpose server, and as shown in FIG. 2, includes a CPU 30. The CPU 30 is connected with a RAM 32, an HDD 34, a communication module 36, an input device 38 and a display driver 40. Furthermore, a display device 42 is connected to the display driver 40.

The CPU 30 is in charge of whole control of the content server 12. The RAM 32 can be used as a working memory and a buffer memory of the CPU 30. The HDD 34 is a main storage of the content server 12, and can be used in order to store contents to be distributed and to store various kinds of data. The contents of this embodiment may be programs (application programs) for various kinds of applications, as described later.

The communication module 36 has a function to be connected to a LAN.

Therefore, the content server 12 can communicate with other computers (management server 16, sale terminal 18, etc.) and the game apparatuses 20 directly or via the network 14.

The input device 38 may be a keyboard, a computer mouse, etc., for example. The display driver 40 is used in order to display various kinds of images on the display device 42 under instructions of the CPU 30. The display driver 40 contains a video RAM (VRAM).

In addition, the electric structure of the content server 12 shown in FIG. 2 is a mere example, and it does not need to be limited to this.

Furthermore, the management server 16 may be a general-purpose server, and may have the same structure as the above-described content server 12, and comprises components such as a processor like a CPU, memories (HDD, ROM, RAM, etc.), a communication module, etc.

Furthermore, the sale terminal 18 may be a so-called POS (Point of Sale) register, and a general-purpose POS system can be used. The sale terminal 18 may comprise a computer that is provided with a processor such as a CPU, memories (HDD, ROM, RAM, etc.), an input device such as a touch panel, a ten key, etc. and a communication module, a receipt printer, a cash drawer, a bar code scanner, etc.

FIG. 3 is a block diagram showing electric structure of the game apparatus 20 shown in FIG. 1. As shown in FIG. 3, the game apparatus 20 may include a CPU 50 that is connected with a RAM 52, a flash memory 54, a wireless communication module 56, an input device 58, a display driver 60 and a D/A converter 64. Furthermore, a display device 62 is connected to the display driver 60, and a speaker 66 is connected to the D/A converter 64.

The CPU 50 is in charge of whole control of the game apparatus 20. The RAM 52 can be used as a working memory and a buffer memory of the CPU 50. The flash memory 54 can be used in order to store a program of an application such as a game, and to store (save) various kinds of data.

The wireless communication module 56 has a function to be connected to a wireless LAN. Therefore, the game apparatus 20 can communicate with other game apparatuses 20 and computers (content server 12 etc.) directly or via the network 14.

The input devices 58 may be various kinds of push buttons or switches provided on the game apparatus 20, and can be used for various kinds of operations such as menu selection and game operation by the user, for example. Here, as the input device 58, there may be provided with a pointing device such as a touch panel, an input module such as a microphone, a camera, etc. instead of the push buttons or switches or together with the push buttons or switches.

The display driver 60 can be used in order to display various kinds of images such as a game image on the display device 62 under instructions of the CPU 50. Although illustration is omitted, the display driver 60 contains a video RAM (VRAM).

The D/A converter 64 converts sound data applied from the CPU 50 into an analog game sound, and outputs the same to the speaker 66. Here, the game sound means sounds required for a game, such as an imitation sound of a game character, a sound effect and music (BGM).

In addition, the electric structure of the game apparatus 20 shown in FIG. 3 is a mere example, and it does not need to be limited to this.

In such a content distribution system 10, the game apparatus 20 can execute a content (application program) that is downloaded (acquired) from the content server 12. In this embodiment, the content server 12 can function as a distribution server for distributing a content, while functioning as a shopping server for purchasing a content. Furthermore, as an application, various kinds of applications such as a game application, an e-mail application, a painting application, a letter exercise application, a language training application, a learning application, etc. can be recited.

In addition, the game apparatus 20 may have structure that can attach a recording medium such as CD, DVD or SD card (memory card), and a game application program may be acquired from this recording medium. In this case, it is possible to purchase a package comprising a recording medium and accessories such as a manual in a toy shop, consumer electronics retail store, on-line shopping or the like.

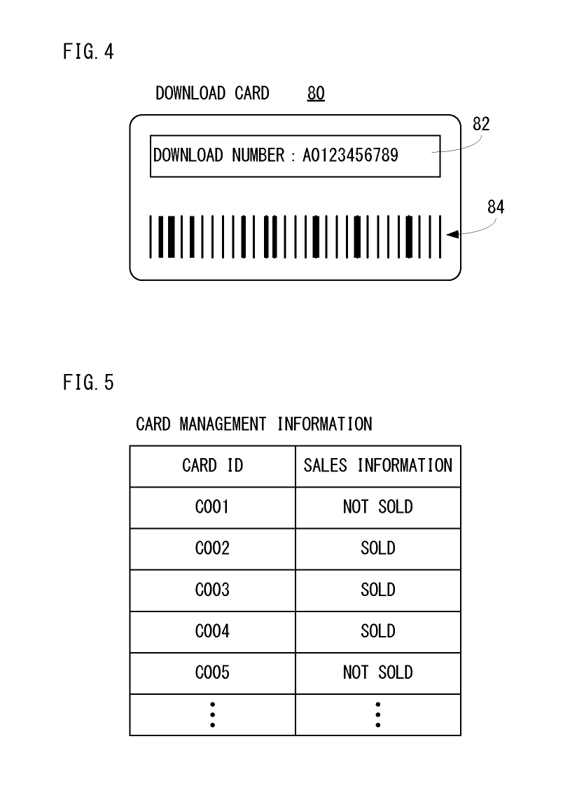

For example, a user can purchase in advance a card (hereinafter, “download card”) 80 for acquiring a content at a store such as a toy shop, consumer electronics retail store or a convenience store. As shown in FIG. 4, a number input column 82 and a bar code 84 may be indicated on the download card 80. In the number input column 82, a download number (exchange number) for acquiring a downloadable (exchangeable) content by this download card 80 is written. The download number may be uniquely applied to the download card 80, and configured with alphanumeric characters, for example. This is an example, and the download number may be configured with only alphabetic character or numerals. Furthermore, the bar code 84 may be a thing that inherent identification information of this download card 80 (hereinafter, called “card ID”) and information (kind information) about a kind of an application program acquirable with this download card 80, etc. are converted into a linear bar code.

Although illustration is omitted, a name of a downloadable content (name of application), etc. may be indicated on a package that encloses the download card 80 or a surface of the download card where the download number and the bar code 84 are not indicated.

The sale terminal 18 shown in FIG. 1 is located in a store that sells such a download card 80. When a user performs settlement of accounts for all the goods to purchase, if the bar code 84 of the download card 80 is read by a bar code scanner, the sale terminal 18 can notify the card ID of a purchased download card 80 to the management server 16 after the settlement of accounts. That is, accounts is settled for the download card 80, and settled information (here, card ID) is notified to the management server 16. In addition, in the sale terminal 18, the kind information that is read from the bar code 84 may be used in order to acquire a price required for purchase of the application corresponding to the download card 80. In addition, data of price information that indicate prices corresponding to the kind information are stored in a memory of the sale terminal 18, and by referring the data, a price of a good that is read by the bar code reader is detected, and a sum total etc. of the good that a customer (user etc.) purchases can be calculated.

The management server 16 stores data (table data) of card management information as shown in FIG. 5 in a memory (HDD, for example). The card management information includes sale information corresponding to the card ID, and the sale information indicates whether a download card 80 indicated by the card ID is sold or not sold. The management server 16 changes the sale information corresponding to the card ID into “sold” if the card ID is notified from the sale terminal 18.

Such card management information (management server 16) can be managed by a selling agency of the download card 80, or a development (sale) source of a content corresponding to the download card 80, or a distribution agency (administrator etc. of the content server 12, in this embodiment) of a content. When starting sale of a new download card 80, in the management server 16, a card ID for each of new download cards 80 is added to the card management information by the administrator etc. At this time, each of the sale information corresponding to each of added card IDs is set as “not sold.”

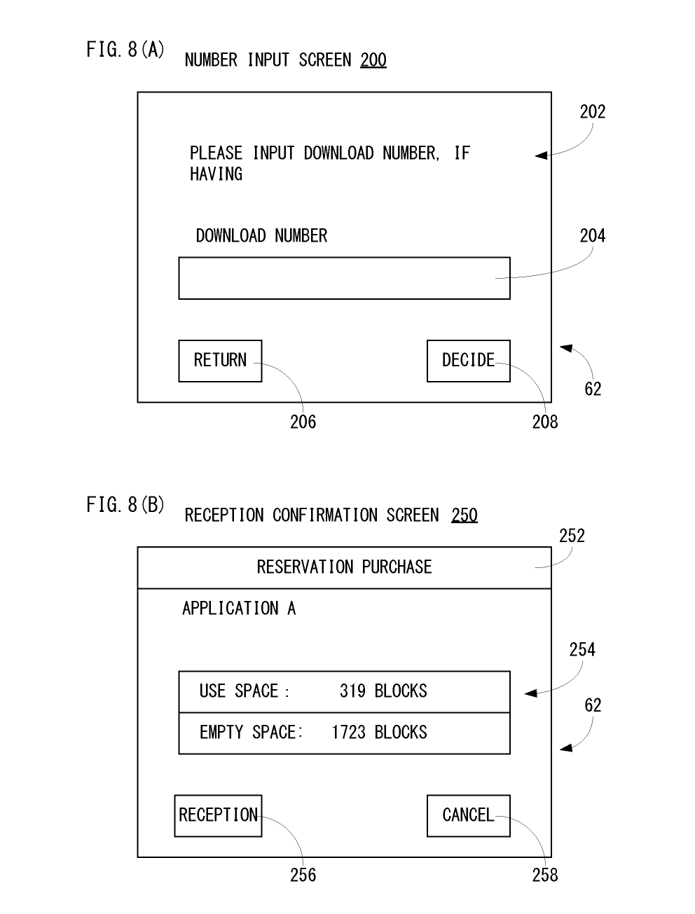

In addition, although the card ID is denoted by the alphanumeric characters of four (4) digits in the example shown in FIG. 5 (FIG. 8 is also the same), this is an example, and should not be limited to this. As long as the download card 80 is individually discriminable, the card ID may be expressed only with numerals or alphabetic characters, and may be denoted by a sign or symbol that a human being cannot decode.

For example, a content can be downloaded if the game apparatus 20 accesses the content server 12 according to an operation of the user on or after a sale start date and time to input a download number (exchange number) indicated on the download card 80.

Although a detailed description is omitted, in this case, the game apparatus 20 accesses a shopping site or a content distribution site that the content server 12 manages, and displays a screen for inputting a download number on the display device 62 of the game apparatus 20 (see FIG. 8(A)), and transmits data of a download number that is input in the screen by the user.

Furthermore, a content can be downloaded if the game apparatus 20 accesses the content server 12 on or after the sale start date and time according to an operation of the user to perform a purchase procedure (accounting processing), for example.

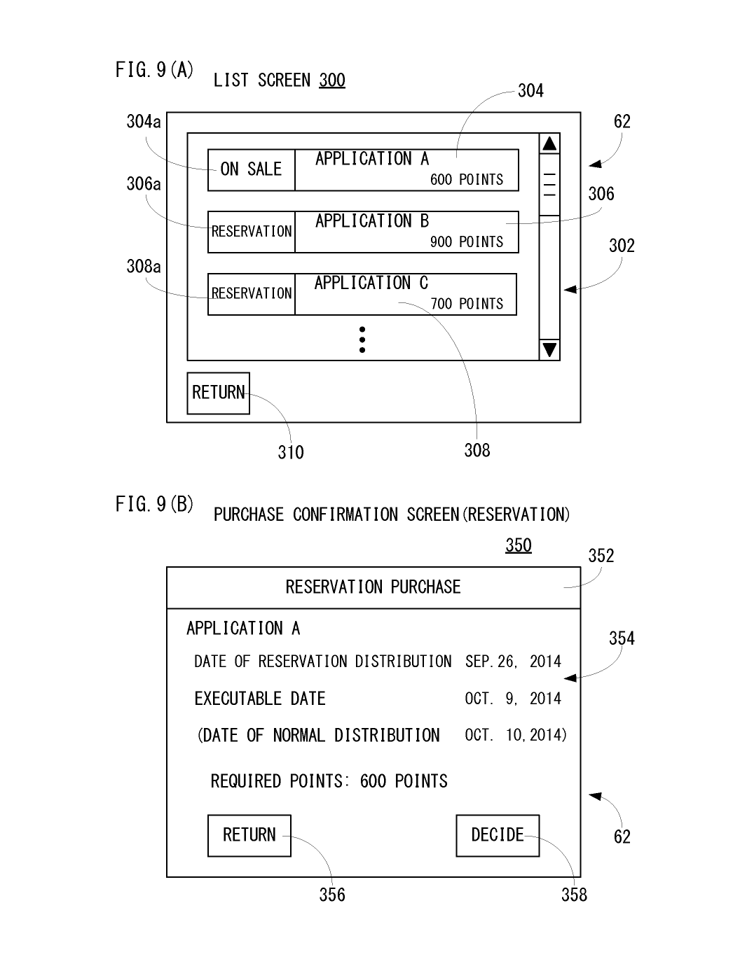

Although a detailed description is omitted, in this case, the game apparatus 20 accesses a shopping site that the content server 12 (administrator thereof etc.) manages, and displays a list of contents on the display device 62 of the game apparatus 20 (see FIG. 9(A)) such that the user can select a content to purchase with reference to this list.

Furthermore, in the accounting processing, a point required for purchase of a content is subtracted from a point (electronic money) having been charged (prepaid) to the game apparatus 20 (user). However, settlement of accounts may be performed by a credit card in the accounting processing.

In addition, in this embodiment, the content server 12 manages the point having been charged for each game apparatus 20 (user) as described later.

It is common that a content is thus downloaded on or after the sale start date and time. However, in this case, if access concentrates on the content server 12 on the sale start date and time, download of a content to the game apparatus 20 takes considerable time. Therefore, it takes great time for a user to use a content, and convenience of download sale may be spoiled.

Therefore, in this embodiment, a content that is reservation-purchased can be used immediately (promptly) on the sale start date and time. Briefly describing, if reservation-purchasing a content, it is possible to download a content (hereinafter, called “reservation content”) that corresponds to that content but starting (execution) thereof is restricted until the sale start date and time. In contrast this reservation content, a content that is executable by the game apparatus 20 can be called “normal content.” In the following, in this specification, when it is unnecessary to distinguish a normal content and a reservation content from each other, they may be called only “content.” Furthermore, in this embodiment, if passing a sale start date and time or an executable date and time, a reservation content becomes changeable to a normal content, and if changed to a normal content, it becomes possible to be used (executed) by the game apparatus 20.

It should be noted that the executable date and time is a date and time that a reservation content becomes usable (executable) by changing it to a normal content, and may be set the same date and time as the sale start date and time of the content, or a date and time prior to the sale start date and time. This is one of privileges of the reservation purchase. Furthermore, a provider of a content can set a price of a reservation content lower than a price of a normal content. If doing in this way, it is possible to increase a buying inclination of a content.

Furthermore, in this embodiment, since a reservation content is acquired in advance, it is possible to prevent access from concentrating on the sale start date and time. Therefore, a load of the content server 12 can be dispersed.

In this embodiment, a normal content includes a resource and an executable code (executable file), and a reservation content includes a resource and a dummy executable code. That is, a reservation content is a content that an executable code in a normal content is changed. In addition, a resource means a major part (main data part) of a content. Therefore, on or after the sale start date and time or the executable date and time, the game apparatus 20 receives a modifying program (patch) from the content server 12 according to an operation of the user, and changes this reservation content to a normal content by applying this modifying program to the reservation content. However, information indicating that it is a reservation content as meta-information is included in a reservation content. Therefore, if a reservation content is changed to a normal content, the information that indicates that it is a reservation content is deleted from the meta-information.

Here, since a data amount of a modifying program is very smaller than those of a normal content and a reservation content, the game apparatus 20 can download the modifying program in a short time. Therefore, if acquiring a reservation content in advance, after reaching the sale start date and time or the executable date and time, by downloading data of a modifying program, and changing the reservation content to a normal content, it can be used (executed) immediately.

That is, when a reservation content is not acquired in advance (when not reservation-purchased), because download of a normal content having a relatively larger data amount is started on or after the sale start date and time, it takes time until the download of the normal content is completed. In contrast, if a reservation content is downloaded in advance, the game apparatus 20 may only download a modifying program with few data amount. Therefore, if the executable date and time is set before than the sale start date and time, of course, even if the executable date and time and the sale start date and time are the same, a user of the game apparatus 20 having downloaded a reservation content can use a normal content earlier than a user of the game apparatus 20 that downloads a normal content.

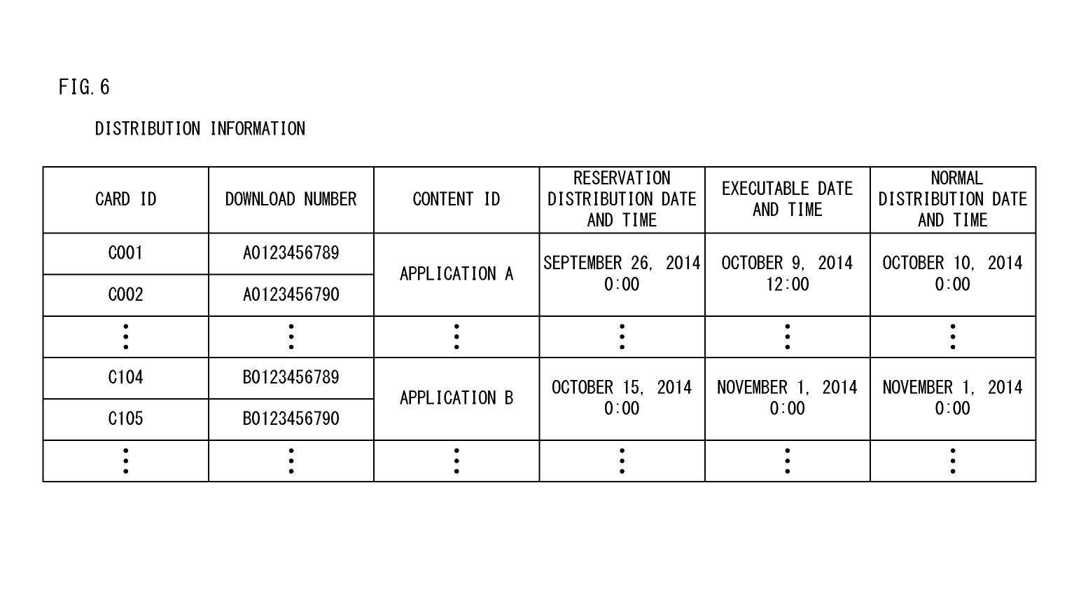

Therefore, the content server 12 of this embodiment is made to store (manage) data (table data) of distribution information as shown in FIG. 6. Such distribution information is registered (updated) by the administrator etc. of the content server 12.

Corresponding to a card ID, a download number, a content ID, a reservation distribution date and time, an executable date and time and a normal distribution date and time are described in the distribution information. Since they are as having mentioned above about the card ID, the download number and the executable date and time, a duplicate description thereof is omitted.

Usually, since a provider of a content is the same as an issuer of a download card 80 or a person who requests issuance of a download card 80 to the issuer, the provider can know easily the card ID and the download number indicated on the download card 80 corresponding to the content.

The content ID is identification information for identifying a content. In an example shown in FIG. 6, although names of applications (application A, application B, etc.) are indicated as content IDs, like the card ID, these may be constituted by alphanumeric characters, alphabetic characters, numerals or signs or symbols that a human being cannot interpret.

The reservation distribution date and time is a date and time that reservation purchase of a content becomes possible. That is, the reservation distribution date and time is a date and time that starts distribution of a reservation content corresponding to a normal content that the content ID indicates. The normal distribution date and time is a date and time of a sale start of a content. That is, the normal distribution date and time is a date and time that starts distribution of a normal content that the content ID indicates.

The administrator etc. of the content server 12 registers a reservation content (reservation application program) into the HDD 34 such that a reservation content can be distributed from the reservation distribution date and time. Furthermore, the administrator etc. of the content server 12 registers a modifying program into the HDD 34 such that distribution of the modifying program is made possible from the executable date and time or the normal distribution date and time. Furthermore, the administrator etc. of the content server 12 registers a normal content (normal application program) into the HDD 34 such that a normal content can be distributed from the normal distribution date and time. The reservation content is deleted when the normal content is registered, for example. That is, the reservation content is replaced with the normal content. Otherwise, the normal content is registered in the HDD 34 (or other server) while changing an access destination (URL) from that of the reservation content.

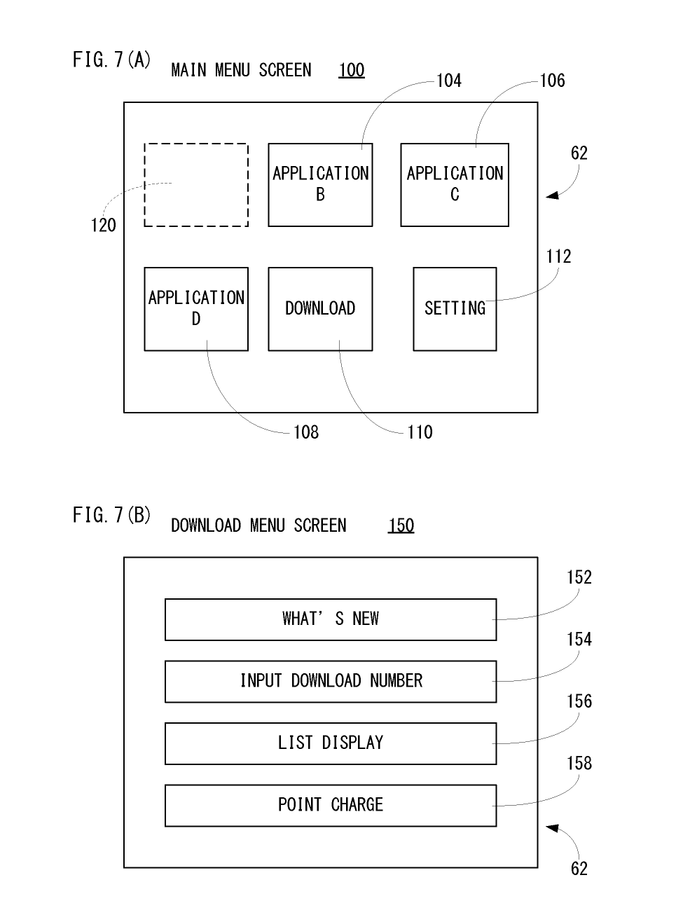

If a main power supply of the game apparatus 20 is turned on or a predetermined button (home button) provided on the game apparatus 20 is pushed, for example, a main menu screen 100 as shown in FIG. 7(A) is displayed on the display device 62. Icons 104, 106, 108, 110 and 112 are provided in this main menu screen 100. The icons 104, 106 and 108 are icons for executing predetermined applications, respectively. An area (additional area) 120 for displaying an icon for added content (application program) is provided in a left side of the icon 104 and above the icon 108.

For example, application programs for applications B, C and D are stored (installed) in the game apparatus 20, and the icon 104, 106 or 108 is selected (turned on), a corresponding application program can be executed (started). When the application program is executed, processing of the application is performed according to the application program. Processing of the application is advanced according to an operation of the user, or advanced automatically by the application program. Furthermore, the processing of the application (application program) is terminated according to an operation of the user or a predetermined event. When the processing of the application is terminated, for example, an execution screen is closed and the main menu screen 100 is displayed on the display device 62. That is, after the application is terminated, a screen returns to a main menu.

Furthermore, if the icon 110 is selected, processing for the download of an application program (content) as mentioned above (hereinafter, called “download processing”) is performed. This download processing will be described in detail later.

Furthermore, if the icon 112 is selected, various kinds of setting for the game apparatus 20 can be performed. For example, it is possible to set information of a user who owns the game apparatus 20 (sex, generation, name, etc.) or date and time information or connection information to a network.

As mentioned above, if the icon 110 is selected and the download processing is started, a download menu screen 150 as shown in FIG. 7(B) is displayed on the display device 62. Strictly described, if the icon 110 is selected, the game apparatus 20 accesses the content server 12. After user authentication is performed between the content server 12 and the game apparatus 20, data of the download menu screen 150 is transmitted to the game apparatus 20 from the content server 12. Therefore, the game apparatus 20 outputs the data of the download menu screen 150 to the display device 62. This is true for other screens displayed in this download processing. However, data of various kinds of screens may be produced at a side of the game apparatus 20.

As shown in FIG. 7(B), icons 152, 154, 156 and 158 are provided in the download menu screen 150. The icon 152 is an icon for displaying What's New (new arrival information). What's New is information about a content put on the market recently (becomes downloadable) or a content scheduled to be sold, for example. If the icon 152 is selected, data of a screen for displaying such What's New is transmitted to the game apparatus 20 from the content server 12. Therefore, it is possible for the user to watch (know) What's New.

The icon 154 is an icon for inputting a download number to download a corresponding content. If this icon 154 is selected, the content server 12 is instructed to input the download number (number input). Then, data of a number input screen is transmitted to the game apparatus 20 from the content server 12. Therefore, a number input screen 200 as shown in FIG. 8(A) is displayed on the display device 62 in the game apparatus 20. An area 202 that displays a message that instructs to input a download number is provided in an upper portion in this number input screen 200. An input column 204 for inputting a download number is provided below the area 202, and further below, a return button 206 and a decide button 208 are provided.

If a user inputs into the input column 204 the download number indicated on the download card 80 and selects (turns on) the decide button 208, the download number that is input into the input column 204 is transmitted to the content server 12.

The content server 12 acquires from the above-mentioned distribution information the card ID corresponding to the download number transmitted from the game apparatus 20, and inquires the management server 16 the sale information about acquired card ID. If “sold” is answered as the sale information from the management server 16, the content server 12 determines that the download card 80 that indicates the download number received from the game apparatus 20 is sold regularly, and the content server 12 transmits data of a reception confirmation screen to the game apparatus 20. Therefore, a reception confirmation screen 250 as shown in FIG. 8(B) is displayed on the display device 62 in the game apparatus 20.

On the other hand, the content server 12 transmits data of an error screen to the game apparatus 20, if “not sold” is answered as the sale information from the management server 16. For example, in an error screen, messages that the download number (exchange number) is wrong and that the download is to be redone after confirming the download number of the download card 80 and so on are displayed.

In addition, when the return button 206 is selected in the number input screen 200, the input of a download number is suspended (forced termination), and a screen returns to a download menu. That is, the number input screen 200 is closed and the download menu screen 150 is displayed on the display device 62.

As shown in FIG. 8(B), the reception confirmation screen 250 includes a display area 252 and a display area 254, and a reception button 256 and a cancel button 258 are provided below the display area 254. The display area 252 is an area for displaying distinction of normal purchase or reservation purchase, and it is displayed in FIG. 8(B) that it is the reservation purchase. The display area 254 is an area for displaying a kind (name) of a content to be downloaded and a space (use space) of the flash memory 54 required to install of the content and a current empty space of the flash memory 54. The reception button 256 is an icon for deciding (instructing) to download a content (here, reservation content). If the reception button 256 is selected, it is transmitted to the content server 12 that there is a confirmation operation of downloading, and the content (here, reservation content) that is purchased at this time is transmitted (distributed) to the game apparatus 20 according to the confirmation operation. The cancel button 258 is an icon for stopping download of a content. If the download of a content is stopped, download processing is terminated, for example, and returning to the main menu. That is, the reception confirmation screen 250 is closed and the main menu screen 100 is displayed on the display device 62.

Although illustration is omitted, when a normal content is to be purchased, it is displayed on the display area 252 that it is the normal purchase. In addition, in a case of the purchase of a normal content, the display area 252 does not need to be provided. Even if doing in this way, it is possible to make distinctive the normal purchase and the reservation purchase. Furthermore, in a case of the normal purchase, a normal content is transmitted to the game apparatus 20.

Furthermore, in this embodiment, shortly after a content is purchased, the content server 12 transmits a content to the game apparatus 20, but it does not need to be limited to this. The content server 12 may transmit a content to the game apparatus 20 according to a predetermined schedule. If doing in this way, when a content is reservation-purchased, it is possible to transmit a reservation content to the game apparatus 20 between the reservation distribution date and time and the executable date and time or the sale start date and time.

Returning to FIG. 7(B), the icon 156 is an icon for displaying information about downloadable applications in a list, and further for downloading a content according to a purchase operation of the user. If the icon 156 is selected, displaying in a list is instructed to the content server 12, and data of a list screen is transmitted to the game apparatus 20 from the content server 12. Therefore, a list screen 300 as shown in FIG. 9(A) is displayed on the display device 62.

As shown in FIG. 9(A), the list screen 300 includes a display area 302 for displaying contents in a list, and icons 304, 306, 308,—are displayed in the display area 302. A return button 310 is provided below the display area 302. The icons 304, 306, 308,—are icons for advancing to a purchase procedure of a corresponding content (application program), respectively. Furthermore, display areas 304a, 306a, 308a,—for displaying information for districting that it is the normal purchase or that it is reservation purchase in the icons 304, 306, 308,—are provided. In an example shown in FIG. 9(A), it is shown that it is the normal purchase by displaying “on sale”, and it is shown that it is the reservation purchase by displaying “reservation.” Here, even if only “reservation” is displayed, it is possible to make distinguishable the normal purchase and the reservation purchase. Furthermore, a return button 310 is an icon for terminating the list display and returning to the download menu.

In FIG. 9(A), if the icon 304 is selected, for example, the game apparatus 20 requires the content server 12 to perform a purchase procedure for the content corresponding to the icon 304, in response to this, data of a purchase confirmation screen is transmitted to the game apparatus 20 from the content server 12. Then, a purchase confirmation screen 350 as shown in FIG. 9(B) is displayed on the display device 62. This purchase confirmation screen 350 is a screen for deciding (confirming) whether a corresponding content (here, application A) is to be purchased.

As shown in FIG. 9(B), the purchase confirmation screen 350 includes a display area 352 and a display area 354, and a return button 356 and a decide button 358 are provided in a lower portion of the display area 354. The display area 352 is an area for displaying distinction of the normal purchase or the reservation purchase, and it is displayed that it is the reservation purchase in FIG. 9(B). The display area 354 is an area for displaying a kind (name) of a content to be downloaded, a distribution date and time (reservation distribution date and time, normal distribution date and time) of the content and a executable date and time and the number of points required for purchase. The return button 356 is a button for stopping the purchase of the content and returning to the list display. Therefore, if the return button 356 is selected, the purchase confirmation screen 350 is closed and the list screen 300 is displayed on the display device 62. The decide button 358 is an icon for deciding (instructing) to purchase the content. If the decide button 358 is selected, the content server 12 is instructed to purchase the content. Responding to this, the content server 12 performs accounting processing for the game apparatus 20 (user) instructing to purchase the content, and transmits the data of the reception confirmation screen 250 to the game apparatus 20 as mentioned above. Since processing after the reception confirmation screen 250 is displayed is the same as the case where the download number is input, a duplicate description is omitted.

Although a detailed description is omitted, in the accounting processing, a point (electronic money) required for the purchase of the content is subtracted from the point having been charged to the game apparatus 20 (user), for example. However, settlement of accounts may be performed by the credit card in the accounting processing.

Thus, in this embodiment, since the accounting processing (settlement of accounts) is performed at the same time that the content is reserved, it is possible to save the time and effort performing these procedures separately. However, a procedure of reservation of a content and a procedure of settlement of accounts may be performed at different timings.

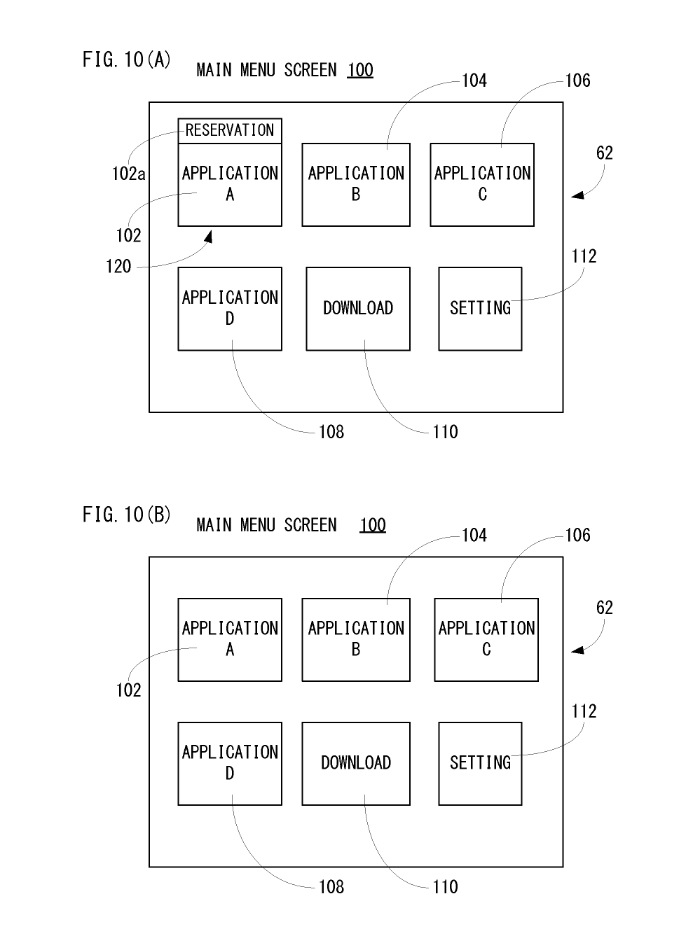

When a content (normal content or reservation content) is downloaded, an icon for starting (executing) the downloaded content is added (displayed) in the main menu screen 100. However, since the starting of a reservation content is restricted, the reservation content is displayed in a manner that it can be understood that it is a reservation content. When a reservation content of the application A is downloaded, for example, as shown in FIG. 10(A), the icon 102 of the application A is displayed in the additional area 120 (see FIG. 7(A)) and a label 102a indicating that it is a reservation purchase (reservation content) is displayed near this icon 102. Thus, since the icon is displayed (added) in the main menu screen 100 also for the reservation content, the user can recognize having performed the reservation purchase of the content easily.

When reaching the executable date and time of a reservation content or the sale start date and time of the corresponding normal content, a message that the reservation content becomes executable is transmitted (notified) to the game apparatus 20 from the content server 12. Then, a message indicating such a state is displayed in a space of the main menu screen 100 in the game apparatus 20. For example, a banner display of a message such as “reservation content becomes executable now” is performed. Therefore, if the user selects an icon of a reservation content (102 in FIG. 10(A)), the game apparatus 20 accesses the content server 12 to download the modifying program (patch) and applies the downloaded modifying program to the reservation content. Then, the reservation content is changed to a normal content. Then, the normal content being changed is started.

However, prior to the executable date and time of a reservation content or the sale start date and time of the corresponding normal content, if the user selects an icon of a reservation content, a message indicating that the reservation content is still inexecutable is displayed on the display device 62, or a sound or voice indicating such a state is output from the speaker 66, or those both are performed. That is, starting of a content is restricted before the executable date and time or the sale start date and time of a normal content.

Furthermore, since information that it is a reservation content is deleted from the meta-information if a reservation content is changed to a normal content by applying a modifying program as mentioned above, the label 102a is non-displayed in the main menu screen 100 as shown in FIG. 10(B).

In addition, if a modifying program is applied, a reservation content is changed to a normal content, and therefore, the modifying program for making it change to a normal content does not need to be applied repeatedly.

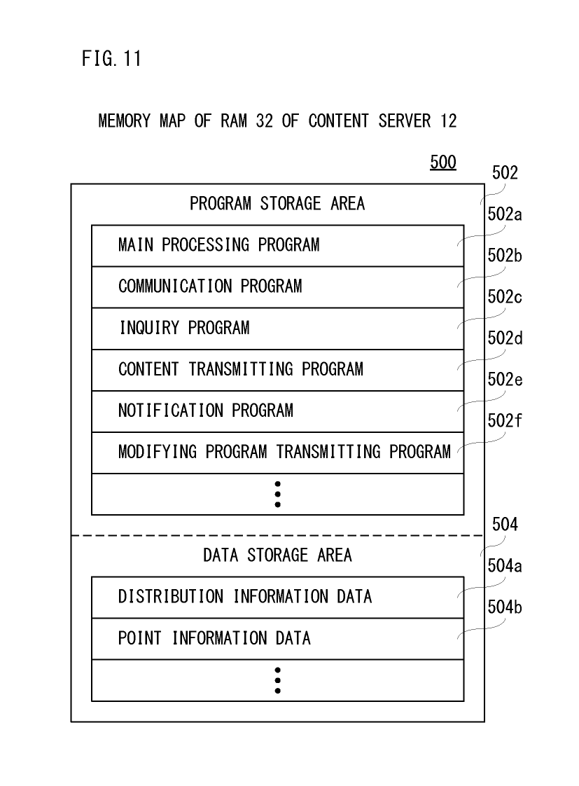

FIG. 11 shows an example of a memory map 500 of the RAM 32 of the content server 12 shown in FIG. 2. Programs and data shown in FIG. 11 are read from the HDD 34 wholly at once or partially and sequentially as necessary to be stored in the RAM 32. As shown in FIG. 11, the RAM 32 includes a program storage area 502 and a data storage area 504. The program storage area 502 is stored with a content distribution program as an example of an information processing program, and the content distribution program is constituted by a main processing program 502a, a communication program 502b, an inquiry program 502c, a content transmitting program 502d, a notification program 502e, a modifying program transmitting program 502f, etc.

The main processing program 502a is a program for processing a main routine in the content server 12. The communication program 502b is a program for communicating with other computers (the management server 16, the sale terminal 18, etc. in this embodiment) and game apparatuses 20. The inquiry program 502c is a program for acquiring, when a download number is transmitted from the game apparatus 20, a corresponding card ID from distribution information (distribution information data 504a described later), and for inquiring the management server 16 whether the download card 80 corresponding to the card ID sells.

The content transmitting program 502d is a program for transmitting a content that a user purchased responding to instructions from the game apparatus 20 that the user owns. The notification program 502e is a program for determining whether there is a reservation content that reaches the executable date and time (the sale start date and time) with reference to the distribution information data 504a, and for notifying, when there is a reservation content that becomes executable, it to the game apparatus 20. When the content server 12 manages the game apparatus 20 that downloads a reservation content, it may be notified the game apparatus 20 that it becomes executable. Otherwise, the content server 12 notifies all the game apparatuses 20 that it becomes executable, and it may be notified to the user selectively according to existence of a reservation content in a side of the game apparatus 20.

The modifying program transmitting program 502f is a program for transmitting, when there is a transmission request of a modifying program from the game apparatus 20 on or after the executable ate and time, a modifying program to the game apparatus 20 responding to the request.

Although illustration is omitted, in the program storage area 502, a program for authenticating a user or a game apparatus 20, a program for selling a content, etc. are also stored.

In the data storage area 504, distribution information data 504a and point information data 504b are stored. The distribution information data 504a is data of the distribution information mentioned above, and is registered (updated) by the administrator etc. of the content server 12. The point information data 504b is data about the point that the game apparatus 20 (user) owns, and is managed for each user.

Although illustration is omitted, other data concerning sale and distribution of contents are stored, and/or counters (timers) and flags required for processing of sale and distribution of contents are provided in the data storage area 504.

Furthermore, although a normal content (normal application program), a reservation content (reservation application program) and a modifying program (patch) are read from the HDD 34 to transmit to the game apparatus 20 in this embodiment, these data may be stored in the RAM 32, and read these data from the RAM 32.

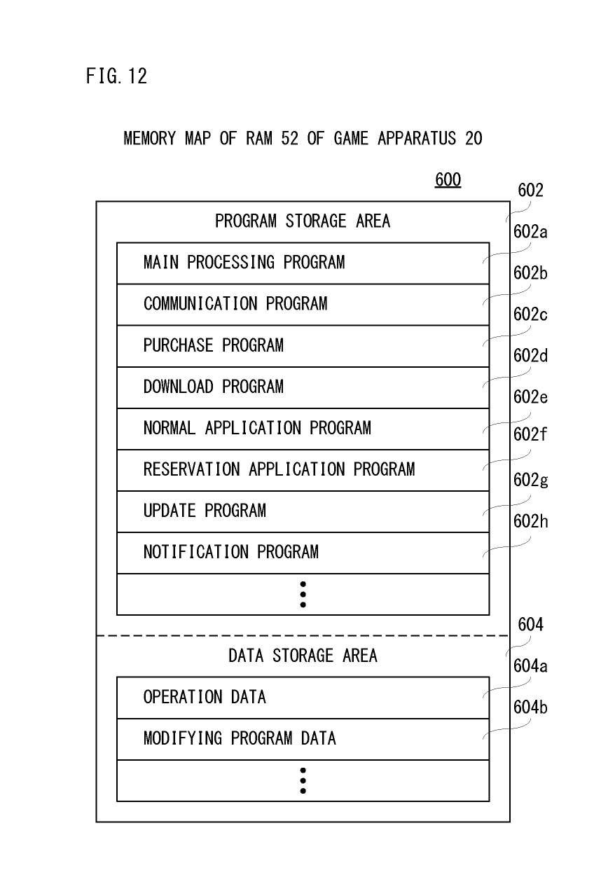

FIG. 12 shows an example of a memory map 600 of the RAM 52 of the game apparatus 20 shown in FIG. 2. Programs and data (data except for operation data 604a and modifying program data 604b) shown in FIG. 12 are read from the flash memory 54 wholly at once or partially and sequentially as necessary to be stored in the RAM 52. As shown in FIG. 12, the RAM 52 includes a program storage area 602 and a data storage area 604. The program store area 602 is stored with an information processing program, and the information processing program is constituted by a main processing program 602a, a communication program 602b, a purchase program 602c, a download program 602d, a normal application program 602e, a reservation application program 602f, an update program 602g, a notification program 602h, etc.

The main processing program 602a is a program for processing a main routine in the game apparatus 20. The communication program 602b is a program for communicating with a computer (content server 12 in this embodiment) or other game apparatuses 20. The purchase program 602c is a program for performing a purchase procedure of a content while accessing the content server 12. The download program 602d is a program for downloading a content that a purchase procedure is performed.

The normal application program 602e is a program for an application that can be executed with the game apparatus 20. In this embodiment, the normal application program (602e etc.) includes resource and executable code. Although only the normal application program 602e is shown in FIG. 12, a plurality of normal application programs can be stored.

The reservation application program 602f is a program of an application that is corresponding to a normal application program (different from 602e) but inexecutable with the game apparatus 20. In this embodiment, in the reservation application program 602f, instead regular executable code, dummy executable code is included. Furthermore, although only the reservation application program 602f is shown in FIG. 12, a plurality of reservation application programs can be stored.

The update program 602g is a program for updating, when execution of the reservation application program (602f etc.) is instructed and when reaching the executable date and time of the corresponding application program, the reservation program by downloading the modifying program data (604b etc.). That is, by applying a patch to a reservation application program, the reservation application program is changed to a normal application program. However, a program that a patch is applied is a reservation application program stored in the flash memory 54. Then, if a reservation application program is changed to a normal application program in the flash memory 54 by applying a patch, a reservation application program that is read from the flash memory 54 and stored in the RAM 52 is replaced with this normal application program. After that, the normal application program being changed is read from the flash memory 54, and stored in the RAM 52.

The notification program 602h is a program for notifying, when execution of the reservation application program (602f etc.) is instructed and but not reaching the executable date and time of the corresponding application program, that the reservation application program is inexecutable (starting is restricted). A message that the reservation application program cannot be started until the executable date and time or the sale start date and time of the corresponding normal application program is displayed on the display device 62, for example, or a sound or voice corresponding to such a message is output from the speaker 66, or those both are performed.

Although illustration is omitted, the program storage area 602 is further stored with a program to produce image data corresponding to the above-mentioned various kinds of screens and an execution screen of an application and to output (display) the produced image data to the display device 62, a program to produce and output a sound, a program to save (keep) data that is produced (updated) through execution of an application, etc.

In the data storage area 604, operation data 604a and modifying program data 604b are stored. The operation data 604a is data that operation signals input from the input device 58 are stored according to a time series. However, an operation signal used for the processing of the CPU 50 is deleted from the data storage area 604. The modifying program data 604b is data of a modifying program (patch) downloaded according to the update program 602g.

Although illustration is omitted, the data storage area 604 is stored with image producing data such as polygon data and texture data, stored with data etc. produced (updated) by executing various application programs, stored with other data concerning execution of various applications, and/or is provided with counters (timers) and flags required for information processing.

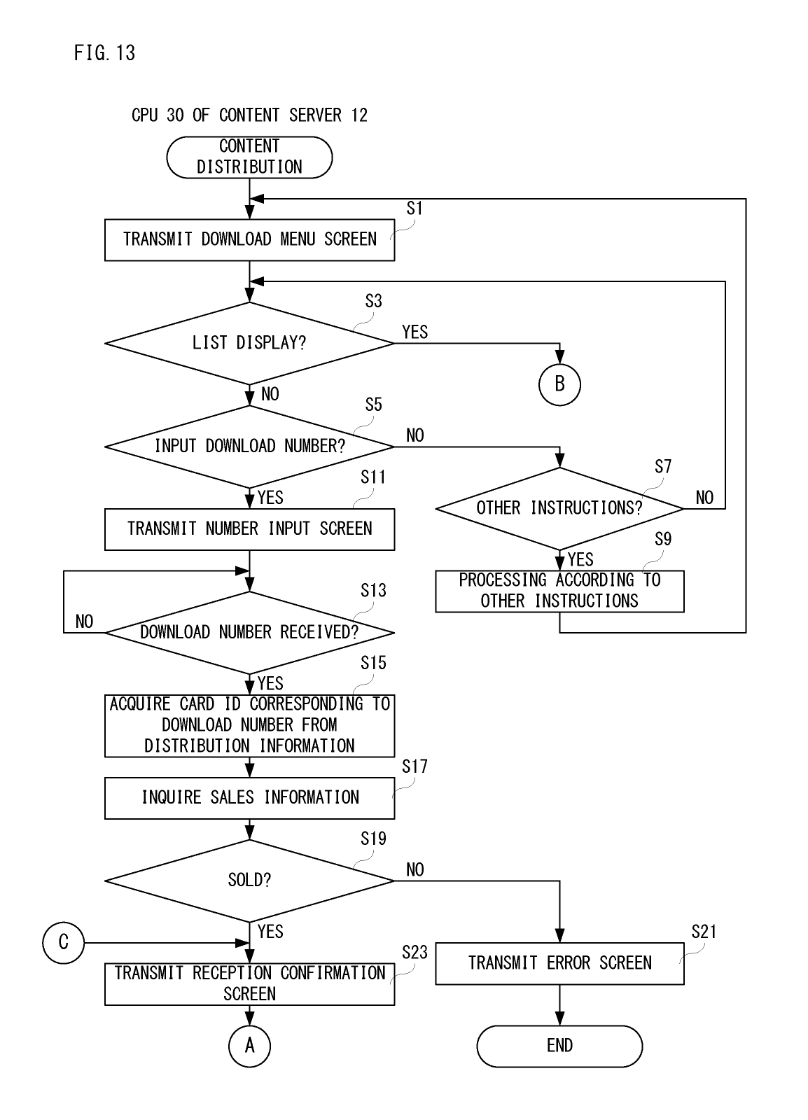

FIG. 13 to FIG. 15 are flowcharts showing content distribution processing of the CPU 30 of the content server 12 shown in FIG. 2. As shown in FIG. 13, if the content distribution processing is started, the CPU 30 transmits data of a download menu screen to the game apparatus 20 in a step S1. It should be noted that this content distribution processing is started on the assumption that the game apparatus 20 accesses the content server 12 according to an operation of the user and that user authentication processing has been performed. Furthermore, since the user authentication is already well known, a description thereof is omitted here. In the following, in this specification, a description will be made on the assumption that the user authentication has been performed, while the game apparatus 20 accesses the content server 12.

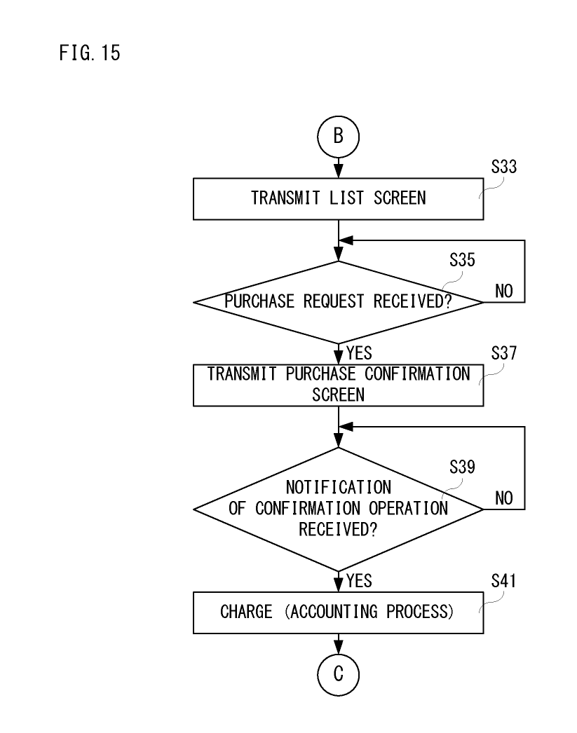

Subsequently, in a step S3, it is determined whether a list display is to be performed. That is, the CPU 30 determines whether a list display is instructed from the game apparatus 20. If “YES” is determined in the step S3, that is, if a list display is to be performed, the process proceeds to a step S33 of FIG. 15. On the other hand, if “NO” is determined in the step S3, that is, if it is not a list display, it is determined, in a step S5, whether a download number is to be input. That is, the CPU 30 determines whether the input of the download number is instructed from the game apparatus 20.

If “NO” is determined in the step S5, that is, if it is not an input of a download number, it is determined whether there are other instructions in a step S7. Here, the CPU 30 determines whether a display of What's New is instructed or a point charge (prepayment) is instructed from the game apparatus 20. If “NO” is determined in the step S7, that is, if other instructions cannot be found, the process returns to the step S3. On the other hand, if “YES” is determined in the step S7, that is, if there are other instructions, processing according to other instructions is performed in a step S9, and the process returns to the step S1. When a display of What's New is instructed, for example, the CPU 30 transmits data of a screen for What's New to the game apparatus 20, and returns to the step S1 responding to instructions of an end (return) from this game apparatus 20. Furthermore, when a point charge is instructed, the CPU 30 transmits data of a screen for a point charge to the game apparatus 20, and updates the point data information 504c with receiving an operation for point charge from the game apparatus 20, and then, returns to the step S1 responding to instructions of an end (return) from the game apparatus 20.

If “YES” is determined in the step S5, that is, if it is an input of a download number, data of a number input screen is transmitted to the game apparatus 20 in a step S11. Then, it is determined whether the data of the download number is received in a step S13. If “NO” is determined in the step S13, that is, if the data of the download number is not received, the process returns to the same step S13. On the other hand, if “YES” is determined in the step S13, that is, if the data of the download number is received, a card ID corresponding to the download number is acquired from distribution information in a step S15. That is, the CPU 30 acquires a card ID indicated corresponding to the received download number with reference to the distribution information indicated by the distribution information data 504a. Then, sale information is inquired in a step S17. In this step S17, the CPU 30 transmits a card ID to the management server 16 by communicating with the management server 16 with controlling the communication module 36, and receives from the management server 16 the sale information of whether the download card 80 that the card ID indicates sells.

Subsequently, in a step S19, it is determined whether the download card 80 that the card ID indicates sells. If “NO” is determined in the step S19, that is, if the download card 80 that the card ID indicates does not sell, in a step S21, the content distribution processing is terminated after transmitting data of an error screen as mentioned above to the game apparatus 20.

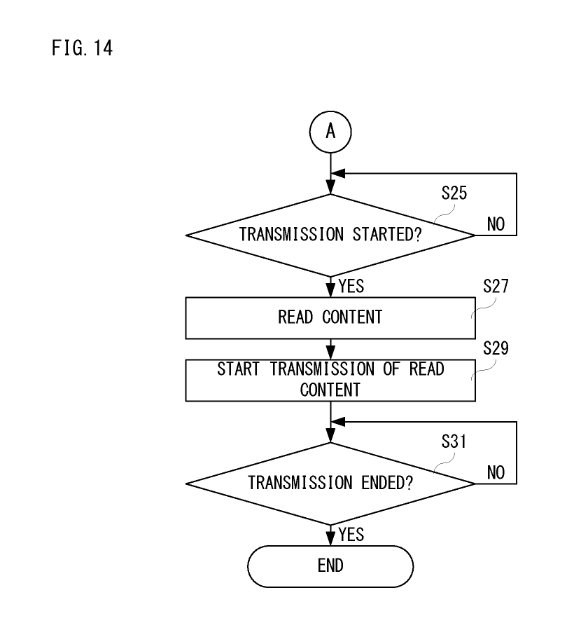

On the other hand, if “YES” is determined in the step S19, that is, if the download card 80 that the card ID indicates sells, data of a reception confirmation screen is transmitted to the game apparatus 20 in a step S23, and it is determined whether it is a transmission start in a step S25 shown in FIG. 14. Here, the CPU 30 determines whether transmission of a content is instructed from the game apparatus 20.

If “NO” is determined in the step S25, that is, if it is not a transmission start, the process returns to the same step S25. On the other hand, if “YES” is determined in the step S25, that is, if it is a transmission start, a corresponding content is read in a step S27, and transmission of the read content is started in a step S29. In addition, in this embodiment, a content may be a normal application program or a reservation application program.

Then, it is determined whether the transmission of the content is ended in a step S31. That is, the CPU 30 determines whether a content is transmitted completely to the game apparatus 20. If “NO” is determined in the step S31, that is, if the transmission of the content is not ended, the process returns to the same step S31. On the other hand, if “YES” is determined in the step S31, that is, if the transmission of the content is ended, the content distribution processing is terminated.

Furthermore, if “YES” is determined in the step S3 as mentioned above, data of a list screen is transmitted to the game apparatus 20 in the step S33 shown in FIG. 15. In a next step S35, it is determined whether a purchase request from the game apparatus 20 is received. If “NO” is determined in the step S35, that is, if a purchase request from the game apparatus 20 is not received, the process returns to the step S35 with no operation. Here, although premised on the user purchases a content, when the user does not purchase a content, that is, when the user pushes the return button 310 in the list screen 300, the process returns to a download menu (returns to the step S1).

On the other hand, if “YES” is determined in the step S35, that is, if a purchase request from the game apparatus 20 is received, it is determined whether a notification of a confirmation operation from the game apparatus 20 is received in a step S39 after transmitting data of a purchase confirmation screen to the game apparatus 20 in a step S37. If “NO” is determined in the step S39, that is, if a notification of the confirmation operation from the game apparatus 20 is not received, the process returns to the same step S39. However, when the user pushes the return button 356 in the purchase confirmation screen 350, since returning to the list screen 300 is instructed, the CPU 30 returns to step S33 in this case.

On the other hand, if “YES” is determined in the step S39, that is, if a notification of the confirmation operation from the game apparatus 20 is received, accounting processing is performed in a step S41, and then, the process proceeds to the step S23 shown in FIG. 13. In addition, in the step S41, the CPU 30 subtracts a point required for the purchase of a content from a point of the game apparatus 20. That is, the point information data 504b is updated.

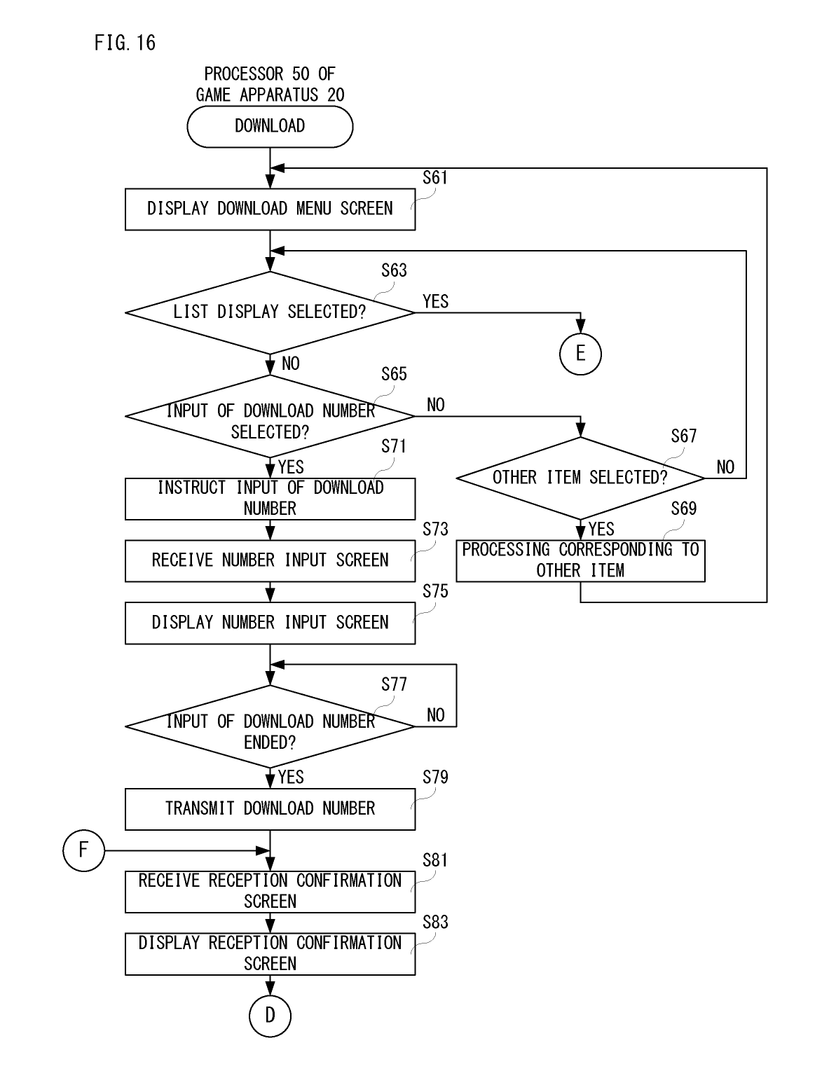

FIG. 16 to FIG. 18 are flowcharts showing download processing of the CPU 50 of the game apparatus 20 shown in FIG. 3, and FIG. 19 is a flowchart showing application execution processing of the CPU 50.

Although a detailed description is omitted, if a main power supply of the game apparatus 20 is turned on, a main menu screen 100 as shown in FIG. 10(A) is displayed on the display device 62. Here, if the icon 110 is pushed, the download processing is executed, and if the icon 102, 104, 106 or 108 is pushed, the application execution processing is executed according to the pushed icon 102, 104, 106 or 108.

In addition, although illustration is omitted, if the icon 112 is pushed, a screen for setting various kinds of information is displayed on the display device 62, and various kinds of information can be set according to an operation of the user.

If the icon 110 is pushed in the main menu screen 100, as shown in FIG. 16, the CPU 50 starts the download processing, and displays a download menu screen 150 as shown in FIG. 7(B) on the display device 62 in a step S61. In addition, it is as having mentioned above that the download processing is started on the assumption that the user authentication has been performed.

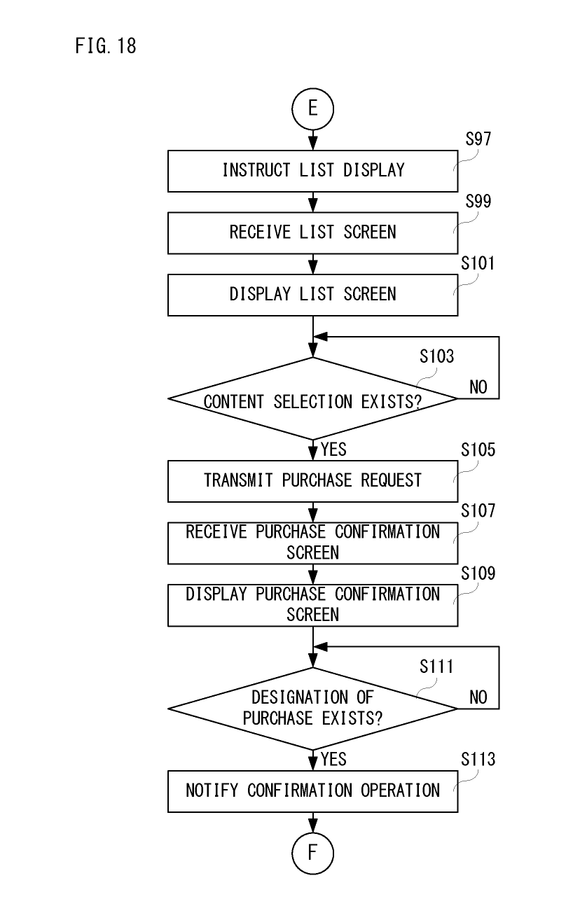

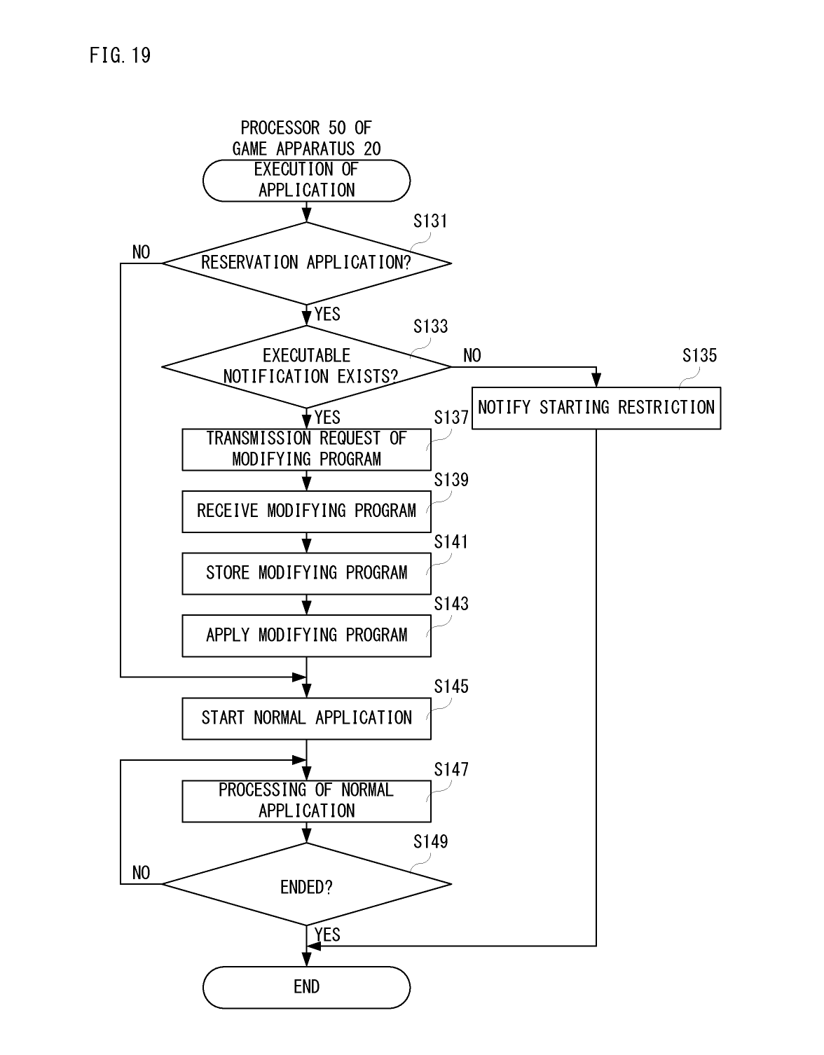

In a subsequent step S63, it is determined whether a list display is selected. Here, the CPU 50 determines whether the icon 156 is pushed. If “YES” is determined in the step S63, that is, if a list display is selected, the process proceeds to a step S97 shown in FIG. 18. On the other hand, if “NO” is determined in the step S63, that is, if a list display is not selected, it is determined whether an input of a download number is selected in a step S65. Here, the CPU 50 determines whether the icon 154 is pushed.

If “NO” is determined in the step S65, that is, if an input of a download number is not selected, it is determined whether other items are selected in a step S67. Here, the CPU 50 determines whether the icon 152 or the icon 158 is pushed. If “NO” is determined in the step S67, that is, if other items are not selected, the process returns to the step S63 with no operation.

On the other hand, if “YES” is determined in the step S67, that is, if another item is selected, after executing processing corresponding to other items in a step S69, the process returns to the step S61. If the icon 152 is pushed, for example, the CPU 50 instructs transmission of What's New to the content server 12, receives data of a screen for What's New, and displays it on the display device 62, and if termination (returning) is instructed, the process returns to the step S61. Furthermore, if the icon 158 is pushed, the CPU 50 instructs a point charge to the content server 12, receives data of a screen of a point charge, displays it on the display device 62, and charge (buy) points (perform prepayment) according to an operation of the user, and then, the process returns to the step S61.

If “YES” is determined in the step S65, that is, if an input of a download number is selected, the CPU 50 instructs an input of a download number to the content server 12 in a step S71. Then, data of a number input screen is received in a step S73, and a number input screen 200 as shown in FIG. 8(A) is displayed on the display device 62 in a step S75.

Then, it is determined whether the input of the download number is ended in a step S77. Here, the CPU 50 determines whether the decide button 208 is pushed with a state where numerals and alphabets are entered in the input column 354. If “NO” is determined in the step S77, that is, if the input of the download number is not ended, the process returns to the same step S77. Although illustration is omitted, when the return button 206 is pushed in the number input screen 200, the CPU 50 stops the input of the download number and returns to a download menu (step S61).

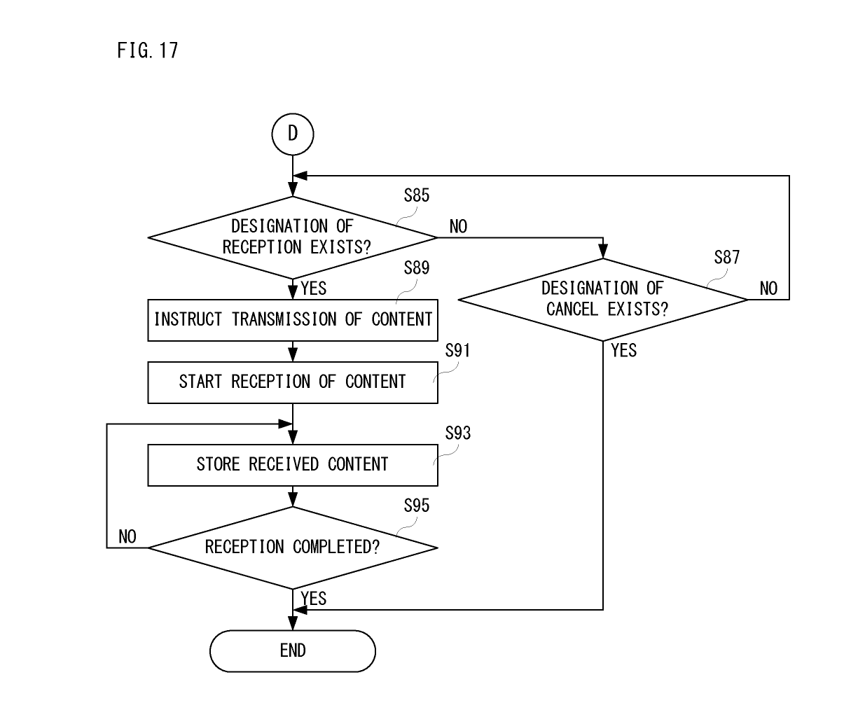

On the other hand, if “YES” is determined in the step S77, that is, if the input of the download number is ended, data of the download number is transmitted to the content server 12 in a step S79. Then, a data of a reception confirmation screen is received in a step S81. That is, if the download card 80 is sold regularly, the data of the reception confirmation screen is transmitted to the game apparatus 20 from the content server 12. A reception confirmation screen 250 as shown in FIG. 8(B) is displayed on the display device 62 in a next step S83, and it is determined whether there is receiving instruction in a step S85 shown in FIG. 17. In a step S85, the CPU 50 determines whether the reception button 256 is pushed.

If “NO” is determined in the step S85, that is, if there is no receiving instruction, it is determined whether there is instruction of cancel in a step S87. Here, the CPU 50 determines whether the cancel button 258 is pushed. If “NO” is determined in the step S87, that is, if there are no instructions to cancel, the process returns to the step S85. On the other hand, if “YES” is determined in the step S87, that is, if there are instructions to cancel, the download processing is terminated. The CPU 50 returns to a main menu, for example after terminating the download processing.

On the other hand, if “YES” is determined in the step S85, that is, if there are receiving instructions, transmission of a content to the content server 12 is instructed in a step S89. Responding to this, as mentioned above, the content server 12 (CPU 30) starts transmission of a content, and the CPU 50 starts reception of the content in a step S91, and stores once the received content to the RAM 52 in a step S93. Then, it is determined whether the reception of the content is completed in a step S95. If “NO” is determined in the step S95, that is, if the reception of the content is not completed, the process returns to the step S93. On the other hand, if “YES” is determined in the step S95, that is, if the reception of the content is completed, the download processing is terminated. Although illustration is omitted, the content is stored (installed) in the flash memory 54 if the reception of the content is completed.

Furthermore, if “YES” is determined in the step S63 as shown in FIG. 16, the content server 12 is instructed to perform a list display in the step S97 shown in FIG. 18. Responding to this, as mentioned above, the content server 12 (CPU 30) transmits data of a list screen, and the CPU 50 receives the data of a list screen in a step S99. Then, the CPU 50 displays a list screen 300 as shown in FIG. 9(A) on the display device 62 in a step S101.

Subsequently, in a step S103, it is determined whether there is selection of a content. It is determined whether the buttons 304, 306 and 308 for contents, etc. are pushed in the list screen 300 shown in FIG. 9(A), for example. If “NO” is determined in the step S103, that is, if a content is not selected, the process returns to the same step S103. Although illustration is omitted, when the return button 310 is pushed in the list screen 300, the CPU 50 ends the list display and returns to a download menu (step S61).

On the other hand, if “YES” is determined in the step S103, that is, if a content is selected, a purchase request for the content is transmitted to the content server 12 in a step S105. Although illustration is omitted, since the game apparatus 20 grasps a point that the game apparatus 20 (user) owns, a purchase request is not transmitted when the point is insufficient. Furthermore, when the point is insufficient, a message indicating that it is necessary to charge points is displayed on the display device 62, for example.

If a purchase request is received, as mentioned above, the content server 12 transmits data of a purchase confirmation screen to the game apparatus 20, and the CPU 50 receives the data of a purchase confirmation screen in a step S107. Then, a purchase confirmation screen 350 as shown in FIG. 9(B) is displayed on the display device 62 in a step S109.

Then, in a step S111, it is determined whether there are any instructions of purchase. That is, the CPU 50 determines whether the decide button 358 is pushed in the purchase confirmation screen 350. If “NO” is determined in the step S111, that is, if there are no instructions of purchase, the process returns to the same step S111. Although illustration is omitted, when the return button 356 is pushed in the purchase confirmation screen 350, the process returns to the list display (step S97). On the other hand, if “YES” is determined in the step S111, that is, if there are instructions of purchase, a confirmation operation (a purchase) is notified to the content server 12 in a step S113, and the process proceeds to a step S81 shown in FIG. 16.

Furthermore, if the icon 102, 104, 106 or 108 is pushed in the main menu screen 100, as mentioned above, executing the corresponding application is instructed, the CPU 50 starts application execution processing as shown in FIG. 19. First, it is determined whether it is a reservation application in a step S131. In the main menu screen 100 shown in FIG. 10(A), it is determined whether the icon 102 is pushed.

If “NO” is determined in the step S131, that is, if it is a normal application, the process proceeds to a step S145 describe later. On the other hand, if “YES” is determined in the step S131, that is, if it is a reservation application, it is determined whether there is any execution possibility notification in a step S133. That is, the CPU 50 determines whether an execution possibility notification is transmitted from the content server 12 for the reservation application that execution thereof is instructed.

If “NO” is determined in the step S133, that is, if there is no execution possibility notification, it is determined that the starting of the reservation application that execution thereof is instructed is restricted, it is notified that the starting is restricted in a step S135, and the application execution processing is terminated. In the step S135, the CPU 50 displays a message indicating that the starting is restricted on the display device 62, outputs a sound or voice indicating that the starting is restricted from the speaker 66, or performs those both.

Furthermore, if “YES” is determined in the step S133, that is, if there is an execution possibility notification, a transmission request of a modifying program is transmitted to the content server 12 in a step S137. Subsequently, a modifying program is received in a step S139, and the modifying program is stored in the data storage area 604 of the RAM 52 in a step S141. Then, the received modifying program (patch) is applied to the corresponding reservation application program in a step S143. Therefore, a reservation application program is modified to be changed to a normal application program. In addition, as mentioned above, what a patch is applied is a reservation application program stored in the flash memory 54. Furthermore, when a reservation application program changes to a normal application program, instead of a reservation application program before change stored in the RAM 52, the normal application program after change is stored in the in the RAM 52.

In the step S145, a normal application that execution thereof is instructed or a normal application that is changed from a reservation application that execution thereof is instructed is started. In a next step S147, processing of a normal application is performed. If a normal application is a game application, for example, game processing is performed according to an operation of the user or irrespective of an operation of the user. Furthermore, if a normal application is an E-mail application, according to an operation of the user, an address, a title, a text, etc. of an E-mail are input, and an E-mail is transmitted, or an E-mail is received.

Then, it is determined whether it is an end in a step S149. In this embodiment, a normal application is terminated according to an operation of the user, or terminated responding to that a predetermined event (game over, for example) occurs during processing of the normal application. If “NO” is determined in the step S149, that is, if it is not an end, the process returns to the step S147. On the other hand, if “YES” is determined in the step S149, that is, if it is an end, the application execution processing is terminated.

According to this embodiment, since a reservation content is downloaded in advance and a modifying program is downloaded at the executable date and time, it is possible to execute immediately a reservation content by changing it to a normal content. Therefore, it is possible to improve convenience of download sale.

Furthermore, according to this embodiment, since a reservation content is downloaded in advance, it is avoidable that access concentrates on the distribution server that distributes a content on the sale start date and time of this content. That is, it is possible to disperse a load of the distribution server.

In addition, although an execution possibility notification is transmitted to the game apparatus from the content server, and the game apparatus accesses the content server to acquire a modifying program in this embodiment, a modifying program may be automatically transmitted (distributed) to the game apparatus from the content server. In such a case, if a modifying program is received, the game apparatus applies a modifying program to a reservation content irrespective of whether the user instructs execution of the reservation content. Therefore, the user is not troubled.

Furthermore, in this embodiment, although an execution possibility notification is transmitted to the game apparatus from the content server, it does not need to be limited to this. For example, the content server transmits to the game apparatus information (date and time information) about the executable date and time or the sale start date and time, and the game apparatus determines whether the executable date and time or the sale start date and time that the date and time information indicates is reached, and when reaching at the executable date and time or the sale start date and time, the game apparatus accesses the content server to acquire a modifying program.

Furthermore, although a reservation content and its modifying program are transmitted from the same content server in this embodiment, these may be transmitted from different servers, respectively. When a further server other than the content server distributes a modifying program, for example, the game apparatus instructs transmission of a modifying program to the further server.

Furthermore, although the content server functions as not only a shopping server but a distribution server in this embodiment, it may be provided with two servers that fulfill these functions discretely. The content server or the distribution server may be provided in plural for each kind of content or for each provider of content.

Furthermore, although a reservation application includes a resource and dummy executable code in this embodiment, it does not need to be limited to this. An application that is encrypted in at least a part thereof may be transmitted as a reservation application. In such a case, a decryption key may be transmitted from the content server according to a request from the game apparatus at the executable date and time or the sale start date and time, or a decryption key may be transmitted automatically from the content server to the game apparatus. Furthermore, when a decryption key is transmitted to the game apparatus automatically from the content server, the game apparatus decrypts, if receiving the decryption key, the reservation content to a normal content with the decryption key irrespective of whether the user instructs execution of the reservation content. Therefore, the user is not troubled.

Furthermore, although the management server is provided separately from the content server in this embodiment, these may be gathered to a single server.

Furthermore, although the game apparatus is shown as an example of an information processing apparatus in this embodiment, it does not need to be limited to this. It is possible to use other information processing apparatuses such as general-purpose PC (desktop PC, a notebook PC, a tablet PC), PDA, a smartphone, a mobile phone, etc. as long as a content can be downloaded and executed.

Although certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What we claimed is:

1. A content distribution system, comprising:
a storing module configured to store a second content that corresponds to a first content that is normal and can be executed by an information processing apparatus, but cannot be executed by the information processing apparatus;
a content transmitting module configured to transmit the second content to the information processing apparatus when settling an account for the first content prior to a sale start of the first content; and
a data transmitting module configured to transmit to the information processing apparatus change data that can change the second content to the first content after transmission of the second content.

2. The content distribution system according to claim 1, wherein the change data is data of a modifying program that can modify the second content.

3. The content distribution system according to claim 2, wherein the first content includes a regular executable code with which a content can be executed, and
the second content includes a dummy executable code with which a content cannot be executed, and
the modifying program modifies the dummy executable code to a regular executable code.

4. The content distribution system according to claim 1, wherein the second content is data that at least a part of the first content is encrypted, and
the change data is data of a decryption key that can decrypt the second content to the first content.

5. The content distribution system according to claim 1, wherein the data transmitting module is configured to transmit automatically the change data to the information processing apparatus.

6. The content distribution system according to claim 1, wherein the data transmitting module is configured to transmit the change data after transmission of the second content on or before the sale start date and time.

7. The content distribution system according to claim 1, wherein
the information processing apparatus comprises
an access module configured to access a predetermined site according to an operation of a user,
a reservation module configured to reserve purchase of the first content before the sale start according to an operation of the user when the access module accesses the predetermined site, and
a settlement instructing module configured to instruct settlement of accounts for the first content according to an operation of the user when the purchase of the first content is reserved by the reservation module.

8. The content distribution system according to claim 7, wherein the content transmitting module is configured to transmit the second content to the information processing apparatus responding to having settled accounts for the first content at a time of reservation by the information processing apparatus.

9. The content distribution system according to claim 1, wherein the information processing apparatus comprises an exchange number transmitting module configured to transmit an exchange number indicated on a trading medium that is associated with the first content purchased prior to the sale start to the content transmitting module according to an operation of the user, and
the content transmitting module is configured to transmit the second content corresponding to the exchange number responding to having received the exchange number that is transmitted by the exchange number transmitting module when accounts is settled for the first content responding to having purchased the trading medium.

10. The content distribution system according to claim 1, wherein
the information processing apparatus comprises
a content receiving module configured to receive the second content transmitted by the content transmitting module, and
an adding module configured to add the second content received by the content receiving module to a content execution menu.

11. The content distribution system according to claim 10, wherein
the information processing apparatus further comprises
a content execution module configured to execute the first content selected in the content execution menu by the user, and
a notification module configured to notify, when the second content is selected by the user in the content execution menu, execution impossibility of the second content.

12. The content distribution system according to claim 1, wherein the content transmitting module is configured to transmit the first content after the sale start.

13. The content distribution system according to claim 1, further comprising a content distribution server that comprises the storing module, the content transmitting module and the data transmitting module, and
the information processing apparatus comprises
a settlement instructing module configured to instruct settlement of accounts for the first content according to an operation of a user,
a content receiving module configured to receive the second content transmitted by the content transmitting module, and
a data receiving module configured to receive the change data transmitted by the data transmitting module.

14. A content distribution server, comprising:
a storing module configured to store a second content that corresponds to a first content that is normal and can be executed by an information processing apparatus, but cannot be executed by the information processing apparatus;
a content transmitting module configured to transmit the second content to the information processing apparatus when accounts is settled for the first content prior to a sale start of the first content; and
a data transmitting module configured to transmit to the information processing apparatus change data that can change the second content to the first content after transmission of the second content.

15. A non-transitory storage medium storing a content distribution program that is executed by a content distribution server comprising a storing module configured to store a second content that corresponds to a first content that is normal and can be executed by an information processing apparatus, but cannot be executed by the information processing apparatus, wherein the content distribution program causes the content distribution server to function as:
a content transmitting module configured to transmit the second content to the information processing apparatus when accounts is settled for the first content prior to a sale start of the first content; and
a data transmitting module configured to transmit to the information processing apparatus change data that can change the second content to the first content after transmission of the second content.

16. A content distribution method of a content distribution server comprising a storing module configured to store a second content that corresponds to a first content that is normal and can be executed by an information processing apparatus, but cannot be executed by the information processing apparatus, wherein the content distribution server performs:
transmitting the second content to the information processing apparatus when accounts is settled for the first content prior to a sale start of the first content; and
transmitting to the information processing apparatus change data that can change the second content to the first content after transmission of the second content.
